(19) United States
(12) Patent Application Publication
(10) Pub. No.: US 2024/0166006 A1
(43) Pub. Date: May 23, 2024

(54) JOINING STRUCTURE FOR SUSPENSION

(71) Applicants: HYUNDAI MOTOR COMPANY, Seoul (KR); KIA CORPORATION, Seoul (KR)

(72) Inventors: Ha Kyung Moon, Incheon (KR); Jae Young Kim, Ulsan (KR); Deok Ki Kim, Hwaseong-si (KR); Jeong Ho Kim, Yongin-si (KR); Dong Gon Kang, Hwaseong-si (KR)

(73) Assignees: HYUNDAI MOTOR COMPANY, Seoul (KR); KIA CORPORATION, Seoul (KR)

(21) Appl. No.: 18/198,556

(22) Filed: May 17, 2023

(30) Foreign Application Priority Data
Nov. 21, 2022 (KR) 10-2022-0155969

(51) Int. Cl. B60G 7/00

(52) U.S. Cl. CPC B60G 7/008; B60G 7/001; B60G 7/005; B60G 2204/43; B60G 2206/8207

(57) ABSTRACT

A joining structure for a suspension includes a lower arm fastened at a first end portion thereof to a vehicle body, a fixed knuckle at which a strut portion is located, a rotary knuckle located inside the fixed knuckle and fastened to a wheel to be rotatable about the fixed knuckle, a fastening unit fastened to the first end portion of the lower arm and a lower end portion of the fixed knuckle, a steering input portion located at the fixed knuckle and applying a steering force to the rotary knuckle during steering, and a tie rod fastened between the fixed knuckle and the vehicle body.

### CROSS REFERENCE TO RELATED APPLICATION

The present application claims priority to Korean Patent Application No. 10-2022-0155969, filed Nov. 21, 2022, the entire contents of which is incorporated herein for all purposes by this reference.

### BACKGROUND OF THE PRESENT DISCLOSURE

### Field of the Present Disclosure

The present disclosure relates to a joining structure for a suspension. More particularly, the present disclosure relates to a joining structure for a suspension, which provides a joining structure between a lower arm and a rotary knuckle of the suspension and a steering input portion, thus allowing each wheel to be independently steered in response to a user's steering input signal.

### Description of Related Art

A part of a vehicle at which a wheel is provided is provided with a suspension to absorb vibration generated between the wheel and a road.

Several types of suspensions are presented, and a suspension suitable for each type of vehicle is selected and applied.

As an exemplary embodiment of the present disclosure, there is a Macpherson suspension shown in FIG. 1.

The Macpherson suspension includes a knuckle, a shock absorber 12 which is provided on an upper portion of the knuckle to absorb vibration, a lower arm 13 which is connected to a lower portion of the knuckle 11, and a stabilizer 14 which is connected to a lower portion of the knuckle 11 or a lower portion of the shock absorber 12.

The knuckle 11 includes a wheel mount part in which a wheel W is provided at a center thereof, a shock absorber connector connected to the shock absorber 12 at the upper portion of the knuckle, and a lower arm connector connected to the lower arm 12 at the lower portion of the knuckle 11.

However, the above structure is problematic in that, when a steering force is applied to the knuckle during steering, a knuckle should be rotated simultaneously with a fixed knuckle, so that there is a structural limitation in applying the steering force to the wheel.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a joining structure for a suspension, which provides a fixed knuckle fastened to a lower arm, and provides a rotary knuckle located at a rotating axis of the fixed knuckle to perform independent rotation, thus including a high steering angle in a front and rear direction thereof.

Furthermore, the present disclosure is to provide a joining structure for a suspension, which provides a tie rod fastened to a fixed knuckle, thus providing stability in a height direction of a vehicle body.

The present disclosure is not limited to the above-mentioned objectives. Other objectives of the present disclosure will be clearly understood by those skilled in the art from the following description. Furthermore, the objectives of the present disclosure may be realized by means and combinations indicated in the claims.

To achieve the objectives of the present disclosure, a joining structure for a suspension includes the following configuration.

According to an exemplary embodiment of the present disclosure, a joining structure for a suspension includes a lower arm fastened at a first end portion thereof to a vehicle body, a fixed knuckle at which a strut portion is located, a rotary knuckle located inside the fixed knuckle and fastened to a wheel to be rotatable about the fixed knuckle, a fastening unit fastened to the first end portion of the lower arm and a lower end portion of the fixed knuckle, a steering input portion located at the fixed knuckle, and applying a steering force to the rotary knuckle during steering, and a tie rod fastened between the fixed knuckle and the vehicle body.

The fixed knuckle may include an upper fixed knuckle at which the strut portion and the steering input portion are fixedly located, and a lower fixed knuckle facing the fastening unit to be fastened to the lower arm.

The joining structure may further include a bearing located at the upper fixed knuckle to be fastened to an upper end portion of the rotary knuckle, and a fastening portion located at the lower fixed knuckle to be fastened to a lower end portion of the rotary knuckle.

The tie rod may be configured so that a second end portion thereof fastened to the fixed knuckle is moved in a height direction of the vehicle with respect to a first end portion thereof facing the vehicle body.

The fastening unit may include a ball joint.

The joining structure may further include a stopper located at the rotary knuckle and configured to be in contact with the fixed knuckle when the rotary knuckle is rotated.

The stopper may include an internal race stopper contacting with the fixed knuckle when an internal race of the wheel is steered, and an external race stopper contacting with the fixed knuckle when an external race of the wheel is steered.

The first end portion of the lower arm may be fastened to the vehicle body through a cam bolt.

The steering input portion may be located at an upper end portion of the fixed knuckle to be parallel to the strut portion.

The lower arm may include at least two extension portions to face the vehicle body.

A central point of the wheel may be located between both end portions to which the two extension portions and the vehicle body are fastened, respectively.

According to an exemplary embodiment of the present disclosure, a joining structure for a suspension may include a lower arm fastened to a vehicle body through two extension portions, a fixed knuckle at which a strut portion is located, a rotary knuckle located inside the fixed knuckle and fastened to a wheel to be rotatable about the fixed knuckle, a fastening unit fastened to a first end portion of the lower arm and a lower end portion of the fixed knuckle, a steering input portion located at the fixed knuckle and applying a steering force to the rotary knuckle during steering, and a tie rod fastened between the fixed knuckle and the vehicle body.

The fixed knuckle may include an upper fixed knuckle at which the strut portion and the steering input portion are fixedly located, and a lower fixed knuckle facing the fastening unit to be fastened to the lower arm.

The tie rod may be fastened to a front surface or a rear surface of the upper fixed knuckle.

The two extension portions may be fastened to the vehicle body through a cam bolt.

The cam bolt may be fastened through the vehicle body and the lower arm in a longitudinal direction of the vehicle, so that the lower arm may be rotated in a height direction with respect to a first end portion thereof fastened to the vehicle body.

A central axis in a widthwise direction of the wheel may be located between fastening points at which the two extension portions are fastened to the vehicle body.

The tie rod may be fastened to and located at a surface of a front of the fixed knuckle.

The present disclosure can obtain the following effects by combining and using the above embodiments and configurations that are to be described below.

The present disclosure provides a rotary knuckle which is rotated independently of a fixed knuckle, thus providing a high degree of freedom of a suspension.

Furthermore, the present disclosure fastens a lower arm and a tie rod to a fixed knuckle, thus providing structural stability capable of absorbing vertical motion applied to a suspension.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates the coupling relationship of a rotary knuckle according to the related art.

FIG. 2 is a side view exemplarily illustrating a joining structure for a suspension according to an exemplary embodiment of the present disclosure.

FIG. 3A is a top view exemplarily illustrating a joining structure for a front-wheel suspension according to an exemplary embodiment of the present disclosure.

FIG. 3B is a top view exemplarily illustrating a joining structure for a rear-wheel suspension according to an exemplary embodiment of the present disclosure.

FIG. 4 is a bottom view exemplarily illustrating a joining structure for a suspension including a rotary knuckle according to an exemplary embodiment of the present disclosure.

FIG. 5A is a side view exemplarily illustrating a joining structure for a suspension during full bump according to an exemplary embodiment of the present disclosure.

FIG. 5B is a side view exemplarily illustrating a joining structure for a suspension during full rebound according to an exemplary embodiment of the present disclosure.

FIG. 6A illustrates a joining structure for a suspension when an internal race rotates 90 degrees, according to an exemplary embodiment of the present disclosure.

FIG. 6B illustrates a joining structure for a suspension when an external race rotates 60 degrees, according to an exemplary embodiment of the present disclosure.

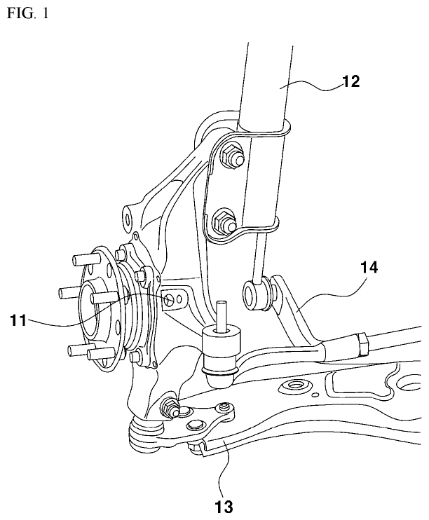

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various embodiments of the present disclosure will be described in detail with reference to the accompanying drawings. The exemplary embodiments of the present disclosure may be embodied in various forms, and the present disclosure should not be construed as being limited to only the exemplary embodiments set forth herein. The exemplary embodiments are provided to more completely explain the present disclosure to those skilled in the art.

Furthermore, terms such as “ . . . knuckle”, “ . . . unit”, and “ . . . part” mean a unit of processing at least one function or operation, which may be implemented by hardware or hardware coupling.

Hereinafter, the exemplary embodiments will be described in detail with reference to the accompanying drawings. The same reference numerals are used throughout the drawings to designate the same or similar components.

Furthermore, term “inner race” described herein means a steering input in which a wheel is rotated along a rear in a longitudinal direction of a vehicle, while term “external race” means a steering input in which the wheel is rotated along a front in the longitudinal direction of the vehicle.

The present disclosure is directed to a joining structure for a suspension, in which a rotary knuckle 100 is located inside a fixed knuckle 200 to be rotatable independently of the fixed knuckle 200.

Moreover, the joining structure for the suspension according to an exemplary embodiment of the present disclosure includes a structure which is fastened to each wheel 800 to be independently steered, and the wheel 800 of the vehicle provided with the corresponding suspension joining structure may include the steering angle of 60 degrees for the external race and to include the steering angle of 90 degrees for the internal race.

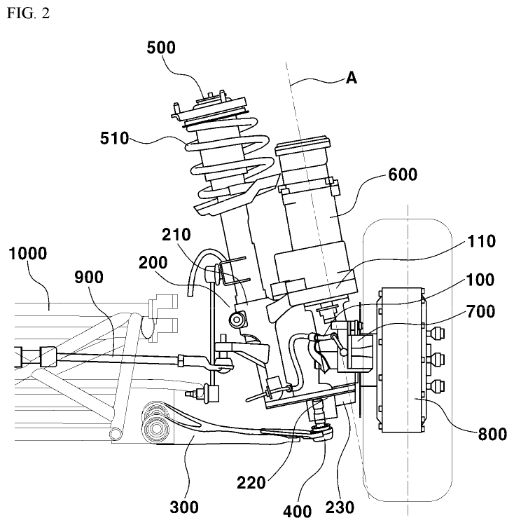

FIG. 2 is a perspective view exemplarily illustrating a joining structure for a suspension according to an exemplary embodiment of the present disclosure.

According to an exemplary embodiment of the present disclosure, the joining structure includes a lower arm 300 which is fastened to a vehicle body 1000 or a frame to be located in a widthwise direction of the vehicle, and a fixed knuckle 200 which is fastened to one end portion of the lower arm 300 and is configured so that a strut portion 500 is located at an upper end portion thereof. Because the strut portion 500 includes a spring portion 510, the strut portion 500 of the present disclosure is used as a concept encompassing a shock absorber including the spring portion 510.

Moreover, the fixed knuckle 200 includes an upper fixed knuckle 210 to which the strut portion 500 and the steering input portion 600 are fastened, and a lower fixed knuckle 220 to which one end portion of the lower arm 300 is fastened. A rotary knuckle 100 configured so that a wheel 800 is integrally secured between the upper fixed knuckle 210 and the lower fixed knuckle 220 is included.

That is, because the rotary knuckle 100 located in a depressed space of the fixed knuckle 200 and fastened at end portions thereof inside both extended end portions of the fixed knuckle 200, respectively, is included, a surface of the rotary knuckle 100 includes a wheel mount portion on which the wheel 800 is mounted. Because the rotary knuckle 100 may include a braking device which is located adjacent to the wheel 800, the rotary knuckle 100, the wheel 800, and the braking device are configured to be integrally rotated.

In an exemplary embodiment of the present disclosure, the rotary knuckle 100 is configured to be fastened between the upper fixed knuckle 210 and the lower fixed knuckle 220 of the fixed knuckle 200. Because the rotary knuckle 100 is rotated about each of upper and lower end portions thereof as a central axis, the rotary knuckle includes same rotating axis as the rotating central axis of the steering input portion 600 located at the upper fixed knuckle 210. Furthermore, the lower end portion of the rotary knuckle 100 is fastened to the fastening portion 230 of the lower fixed knuckle 220, so that the rotary knuckle 100 is rotated about each of the upper fixed knuckle 210 and the lower fixed knuckle 220.

Moreover, the steering input portion 600 is configured to be fastened to the rotary knuckle 100 so that a steering force corresponding to a user's steering input is applied. In an exemplary embodiment of the present disclosure, the steering input portion 600 may include a steering motor which is configured to receive an electronic signal and thereby change the steering angle of the rotary knuckle 100. The steering input portion 600 may be configured to be fastened to the fixed knuckle 200 while being in parallel to the strut portion 500. In an exemplary embodiment of the present disclosure, the strut portion 500 is fastened to an internal surface of the fixed knuckle 200 and the steering input portion 600 is located at a position corresponding to the upper end portion of the fixed knuckle 200 to pass through the fixed knuckle 200.

According to an exemplary embodiment of the present disclosure, when the steering input portion 600 includes the steering motor, the upper end portion 110 of the rotary knuckle 100 and the steering motor may be fixed, and the steering motor may rotate the rotary knuckle 100 in response to the user's steering input.

The steering input portion 600 and the rotary knuckle 100 pass through the upper end portion of the fixed knuckle 200 to be fastened inside the fixed knuckle 200. In an exemplary embodiment of the present disclosure, the steering input portion 600 and the rotary knuckle 100 are fastened through a rotation transfer unit to transmit the rotating force of the steering input portion 600 to the rotary knuckle 100. The rotation transfer unit of the present disclosure may include a spline rod configured as the rotating central axis of the steering input portion 600, and an inlet located at one end portion of the rotary knuckle so that the spline rod is inserted therein. The inlet may be located at the upper end portion of the rotary knuckle 100.

Moreover, a bearing 110 is inserted into an end portion where the rotary knuckle 100 and the fixed knuckle 200 face each other so that the rotation transfer unit of the steering input portion 600 is rotatably inserted into the upper end portion of the rotary knuckle 100. Thus, when the rotary knuckle 100 is rotated by the rotating force of the steering input portion 600, the upper end portion of the rotary knuckle 100 is rotated in a low friction state with respect to the upper end portion of the fixed knuckle 200.

One end portion of the lower arm 300 and the lower end portion of the fixed knuckle 200 are coupled through the fastening unit 400, so that the fastening unit 400 is prevented from being rotated about the central axis in the height direction of the fixed knuckle 200 and absorbs the vertical motion applied from the wheel 800. Moreover, because the fastening unit 400 may include a ball joint, the rotary knuckle 100 may be freely rotated about the fastening unit 400.

One end portion of the lower arm 300 is fastened to the vehicle body 1000 via a cam bolt. The cam bolt is movable upwards and downwards with respect to the vehicle body 1000, so that the camber of the wheel 800 may be adjusted. Moreover, the lower arm 300 includes a degree of freedom so that the other end portion fastened to the lower fixed knuckle 220 is movable upwards and downwards with respect to one end portion fastened to the vehicle body 1000.

Therefore, the rotary knuckle 100 may be rotated inside the fixed knuckle 200 independently of the fixed knuckle 200, and the fixed knuckle 200 may be fixed to the lower arm 300 and the strut portion 500.

The fastening unit 400 is configured at a position adjacent to the lower end portion of the fixed knuckle 200 into which the lower end portion 120 of the rotary knuckle 100 is inserted. The fastening unit 400 is located at the lower fixed knuckle 220. In an exemplary embodiment of the present disclosure, the ball bearing 110 of the fastening unit 400 is inserted into the lower fixed knuckle 220.

A tie rod 900 is fastened at one end portion thereof to the vehicle body 1000, and is fastened at the other end portion thereof to a side of the fixed knuckle 200 fastened to the strut portion 500. The tie rod 900 is fastened to the fixed knuckle 200 via a nut of the tie rod 900. Moreover, the other end portion of the tie rod 900 fastened to the fixed knuckle 200 may be moved to the upper or lower end portion in the height direction of the vehicle with respect to one end portion fixed to the vehicle body 1000. The tie rod 900 fastened to the vehicle body 1000 may be fastened to a member mount to be movable in the height direction with respect to the member mount.

The tie rod 900 is fastened to one side of a front or rear of the fixed knuckle 200. Thus, even when the internal race or the external race of the wheel 800 includes the rotation angle of 90 degrees, it may be located to prevent interference with the wheel 800 and a tire.

That is, the lower arm 300 and the tie rod 900 are fastened to the fixed knuckle 200, and are moved integrally with the wheel 800 with respect to one end portion located at the vehicle body 1000 to guide the vertical motion of the wheel 800 according to the bump or rebound state with respect to the vehicle body 1000.

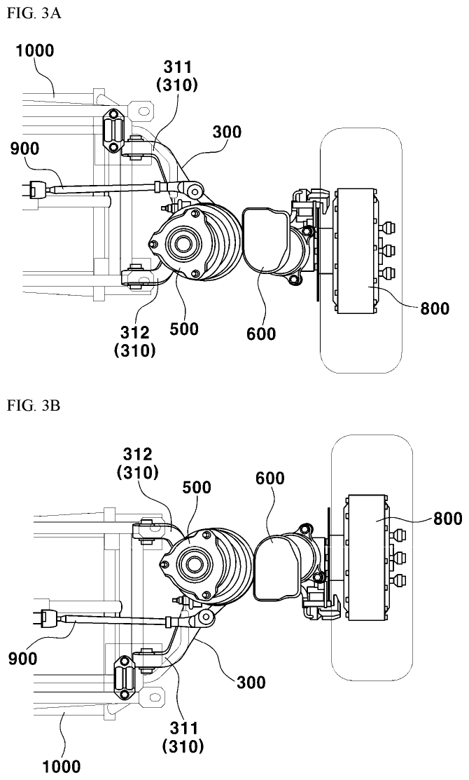

FIG. 3A is a top view exemplarily illustrating a joining structure for a front-wheel suspension according to an exemplary embodiment of the present disclosure, and FIG. 3B is a top view exemplarily illustrating a joining structure for a rear-wheel suspension according to an exemplary embodiment of the present disclosure.

As shown in the drawings, the joining structure includes the rotary knuckle 100 fastened to the wheel 800, and the fixed knuckle 200 is located to surround the rotary knuckle 100. The steering input portion 600 is fastened to the upper end portion of the fixed knuckle 200, and the strut portion 500 is located to substantially include the same angle as the rotating axis as the steering input portion 600. The joining structure includes the lower arm 300 fastened to the lower end portion of the fixed knuckle 200 through the fastening unit 400, and the other end portion of the lower arm 300 includes at least two extension portions 310 secured to the vehicle body 1000.

In an exemplary embodiment of the present disclosure, each of the two extension portions 310 is fastened to the vehicle body 1000 through a cam bolt. The cam bolt may be located through the longitudinal direction of the vehicle body 1000 so that one end portion of the lower arm 300 fastened to the fixed knuckle 200 may be moved in a vertical direction thereof.

The two extension portions 310 including different fastening points in the longitudinal direction of the vehicle body 1000 are configured so that the central axis of the wheel 800 on the top view is located between the fastening points of the extension portions 310 and the vehicle body 1000.

In the case of the front-wheel suspension structure shown in FIG. 3A, a first extension portion 311 located at a front end portion in the longitudinal direction of the vehicle may be configured at a position relatively distant from the central axis of the wheel 800 compared to a second extension portion 312 located at a rear end portion. Furthermore, in the case of the joining structure for the rear-wheel suspension, the first extension portion 311 located at the front end portion in the longitudinal direction of the vehicle may be configured at a position relatively near to the central axis of the wheel 800 compared to the second extension portion 312 located at the rear end portion.

In comparison, in the case of the rear-wheel suspension structure shown in FIG. 3B, a first extension portion 311 located at a front end portion in the longitudinal direction of the vehicle may be configured at a position relatively near to the central axis of the wheel 800 compared to a second extension portion 312 located at a rear end portion. Furthermore, in the case of the joining structure for the rear-wheel suspension, the first extension portion 311 located at the front end portion in the longitudinal direction of the vehicle may be configured at a position relatively distant from the central axis of the wheel 800 compared to the second extension portion 312 located at the rear end portion.

Accordingly, due to the configuration of the first extension portion 311 and the second extension portion 312 of the lower arm shown in FIG. 3A and FIG. 3B, lateral stiffness applied from the lower arm 300 is increased, and braking stiffness is also increased.

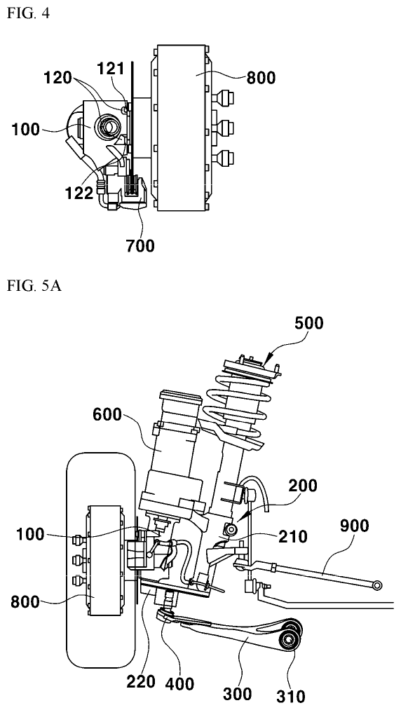

FIG. 4 is a rear view exemplarily illustrating the rotary knuckle 100 according to an exemplary embodiment of the present disclosure.

As shown in the drawing, the rotary knuckle 100 includes a wheel mounting portion to which the wheel 800 is fastened, and is rotated integrally with the wheel 800 in response to a steering angle input. Moreover, the rotary knuckle 100 is configured to rotate about each of the upper and lower end portions thereof fastened to the fixed knuckle 200. In an exemplary embodiment of the present disclosure, the rotary knuckle 100 is configured so that the external race includes the rotation angle of 60 degrees and the internal race includes the rotation angle of 90 degrees.

The rotary knuckle 100 rotated in the instant way includes a stopper 120 as a component for preventing the abnormal rotation of the rotary knuckle 100 when it is rotated beyond a set rotation angle about a pale of the steering input portion 600 or the fixed knuckle 200.

The stopper 120 may be located on the rear surface of the rotary knuckle 100 adjacent to the lower fixed knuckle 220, and includes an internal race stopper 121 located at a front position in the longitudinal direction of the vehicle and an external race stopper 122 located at a rear position.

In the case of the internal race stopper 121, the internal race stopper 121 is in contact with the lower fixed knuckle 220 to limit the rotation amount of the rotary knuckle 100 when an internal race angle is more than 90 degrees when an oversteering angle is input. Furthermore, the external race stopper 122 is in contact with the lower fixed knuckle 220 to limit the rotation of the rotary knuckle 100 when a rotation amount exceeding 60 degrees is applied to the rotary knuckle 100 through the input of an oversteering angle during the steering of the external race.

Accordingly, when a rotation amount more than that of the steering angle input is applied to the rotary knuckle 100, the stopper 120 is configured to limit the over-rotation of the rotary knuckle 100 due to shocks input to a motor pale of the steering input portion or the vehicle, and is configured to be located at the lower end portion of the rotary knuckle 100 in consideration of the rotation amount of each of the external and internal races.

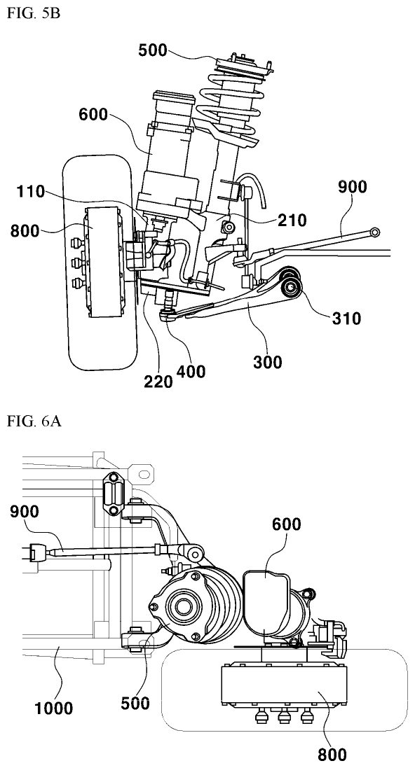

FIG. 5A illustrates the vertical movement of the tie rod 900 and the lower arm during the full bump of the vehicle according to an exemplary embodiment of the present disclosure.

As shown in the drawings, when the central point of the wheel 800 is moved upward according to a full bump state in the driving environment of the vehicle, the other end portion of the tie rod 900 fastened to the fixed knuckle 200 with one end portion of the tie rod 900 fastened to the vehicle body 1000 as an axis is moved upward in the height direction thereof. Moreover, the other end portion thereof is moved upward in the height direction about one end portion of the lower arm 300 fastened to the vehicle body 1000 via a cam bolt.

That is, the tie rod 900 and the lower arm 300 are rotated about one end portion of the tie rod 900 fastened to the vehicle body 1000 and one end portion of the lower arm 300 fastened to the vehicle body 1000 in response to the vertical movement of the wheel 800, and is moved integrally with the wheel 800.

In comparison, FIG. 5B illustrates the vertical movement of the tie rod 900 and the lower arm 300 during the full rebound of the vehicle according to an exemplary embodiment of the present disclosure.

The wheel 800 is moved downwards with respect to the vehicle body 1000 in the full rebound state where the wheel 800 of the vehicle is moved downward, and one end portion of the tie rod 900 and one end portion of the lower arm 300 fastened to the fixed knuckle 200 are moved downwards in the height direction of the vehicle integrally with the wheel 800. That is, one end portion of the tie rod 900 and one end portion of the lower arm 300 are moved integrally with the wheel 800, the tie rod 900 is rotated about the vehicle body 1000, and the lower arm 300 is rotated about one end portion to which the extension portion 310 of the lower arm 300 and the vehicle body 1000 are fastened.

As shown in FIG. 5A and FIG. 5B, the tie rod 900 and the lower arm 300 fastened to the vehicle body 1000 are rotated about the position where they are fastened to the vehicle body 1000 even when the wheel 800 moves in the vertical direction, providing the motion stability of the vehicle.

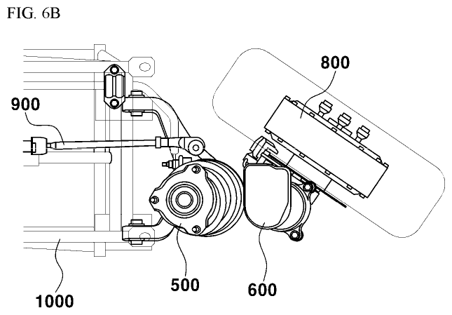

FIG. 6A illustrates a state where the internal race of the wheel 800 rotates 90 degrees, and FIG. 6B illustrates a state where the external race of the wheel 800 rotates 60 degrees.

The drawing shows the rotating state of the internal race of the wheel 800, and the steering input portion 600 is configured to switch the wheel 800 to a state in which it is rotated 90 degrees to the rear of the vehicle in response to the steering angle input. Thus, the rotary knuckle 100 is fastened to the rotating axis of the steering input portion 600 through the upper fixed knuckle 210 at which the steering input portion 600 is located, and the rotary knuckle 100 is rotated about the fixed knuckle 200 integrally with the wheel 800 in response to the rotation of the steering input portion 600.

In a state where the wheel 800 is rotated 90 degrees in the direction of the internal race, the tie rod 900 is located at the front end portion of the fixed knuckle 200 so as not to interfere with the steering change of the wheel 800.

In contrast, as shown in FIG. 6B, when the wheel 800 rotates in the direction of the external race, the wheel 800 is controlled to be rotated with one end portion facing the tie rod 900, and the wheel 800 is located adjacent to one end portion where the tie rod 900 is fastened to the fixed knuckle 200. Therefore, to avoid interference between the fastening point of the tie rod 900 and the rotation angle of the wheel 800 when the external race rotates, the rotation amount of the wheel 800 in the direction of the external race includes a small rotation angle compared to the rotation amount of the wheel 800 in the direction of the internal race.

However, a position where the tie rod 900 is fastened to the fixed knuckle 200 may be located on the front or rear surface of the fixed knuckle 200 in the longitudinal direction of the vehicle, and an angle at which the wheel 800 is rotated in an adjacent direction where the tie rod 900 is fastened may be set to be smaller than an angle at which the wheel is rotated in a direction far away from the tie rod 900.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A joining structure for a suspension, the joining structure comprising:
a lower arm fastened at a first end portion of the lower arm to a vehicle body;
a fixed knuckle at which a strut portion is located;
a rotary knuckle located inside the fixed knuckle and fastened to a wheel to be rotatable about the fixed knuckle;
a fastening unit fastened to the first end portion of the lower arm and a lower end portion of the fixed knuckle;
a steering input portion located at the fixed knuckle, and applying a steering force to the rotary knuckle during steering; and
a tie rod fastened between the fixed knuckle and the vehicle body.

2. The joining structure of claim 1, wherein the fixed knuckle includes:
an upper fixed knuckle at which the strut portion and the steering input portion are fixedly located; and
a lower fixed knuckle facing the fastening unit to be fastened to the lower arm.

3. The joining structure of claim 2, further including:
a bearing located at the upper fixed knuckle to be fastened to an upper end portion of the rotary knuckle; and
a fastening portion located at the lower fixed knuckle to be fastened to a lower end portion of the rotary knuckle.

4. The joining structure of claim 1, wherein the tie rod is configured so that a second end portion of the tie rod fastened to the fixed knuckle is moved in a height direction of a vehicle with respect to a first end portion of the tie rod facing the vehicle body.

5. The joining structure of claim 1, wherein the fastening unit includes a ball joint.

6. The joining structure of claim 1, further including:
a stopper located at the rotary knuckle, and configured to be in contact with the fixed knuckle when the rotary knuckle is rotated.

7. The joining structure of claim 6, wherein the stopper includes:
an internal race stopper contacting with the fixed knuckle when an internal race of the wheel is steered; and
an external race stopper contacting with the fixed knuckle when an external race of the wheel is steered.

8. The joining structure of claim 1, wherein the first end portion of the lower arm is fastened to the vehicle body through a cam bolt.

9. The joining structure of claim 1, wherein the steering input portion is located at an upper end portion of the fixed knuckle to be parallel to the strut portion.

10. The joining structure of claim 1, wherein the lower arm includes at least two extension portions to face the vehicle body.

11. The joining structure of claim 10, wherein a central point of the wheel is located between end portions to which the at least two extension portions and the vehicle body are fastened, respectively.

12. A joining structure for a suspension, the joining structure comprising:
a lower arm fastened to a vehicle body through first and second extension portions;
a fixed knuckle at which a strut portion is located;
a rotary knuckle located inside the fixed knuckle and fastened to a wheel to be rotatable about the fixed knuckle;
a fastening unit fastened to a first end portion of the lower arm and a lower end portion of the fixed knuckle;
a steering input portion located at the fixed knuckle, and applying a steering force to the rotary knuckle during steering; and
a tie rod fastened between the fixed knuckle and the vehicle body.

13. The joining structure of claim 12, wherein the fixed knuckle includes:
an upper fixed knuckle at which the strut portion and the steering input portion are fixedly located; and
a lower fixed knuckle facing the fastening unit to be fastened to the lower arm.

14. The joining structure of claim 13, wherein the tie rod is fastened to a front surface or a rear surface of the upper fixed knuckle.

15. The joining structure of claim 12, wherein the first extension portion and the second extension portion are fastened to the vehicle body through a cam bolt.

16. The joining structure of claim 15, wherein the cam bolt is fastened through the vehicle body and the lower arm in a longitudinal direction of a vehicle, so that the lower arm is rotated in a height direction with respect to an end portion of the lower arm fastened to the vehicle body.

17. The joining structure of claim 15, wherein a central axis in a widthwise direction of the wheel is located between fastening points at which the first extension portion and the second extension portion are fastened to the vehicle body.

18. The joining structure of claim 12, wherein the tie rod is fastened to and located at a surface of a front of the fixed knuckle.
